(19) United States
(12) Patent Application Publication
(10) Pub. No.: US 2011/0211174 A1
(43) Pub. Date: Sep. 1, 2011

(54) Portable Shadow Screen Kit

(76) Inventor: Terry Curtis, Las Vegas, NV (US)

(21) Appl. No.: 12/713,893

(22) Filed: Feb. 26, 2010

(51) Int. Cl. G03B 21/28; G03B 21/14; B23P 11/00

(52) U.S. Cl. 353/80; 29/428

(57) ABSTRACT

A self-contained, washable, portable, shadow screen kit is provided, which includes a generally rectangular side-and-back exterior enclosure, a light source, and a stretched front shadow screen. In one aspect, the side-and-back exterior enclosure includes four corner upright posts supported by four bases, four top horizontal rods connecting the corner upright posts, and drapes to prevent light bleed. Preferably a mirror, mirror stand, and a lightweight ceiling comprising a darkening structure (such as rigid panels or blackout fabric) supported by a ceiling frame are also included. A shadow, cast on the back of the taut screen, is viewable from the front for entertainment or photography. An opaque object is positioned between the light from the light source and the screen. The shadow screen kit is particularly suited for shadow dancing, photography, or videography. The shadow screen kit is easily assembled and disassembled for transport between venues or for storage between uses.

### BACKGROUND OF THE INVENTION

The present invention relates generally to a portable shadow screen kit, and more particularly, but not by way of limitation, to a transportable, washable, reusable portable shadow screen kit having a light source and screen for casting a silhouette image suitable for entertainment or photography.

### BACKGROUND INFORMATION

The shadow screen has a long history, dating back more than 2000 years in China and India. It was originally designed for Puppet Theater; later, stage actors and dancers began to utilize the shadow screen for the interesting moving silhouettes that could be produced by the human body.

The silhouette image cast upon the screen is created by a dancer (or actor, puppet, etc.) positioned in front of a light and behind the screen. The rays from the light source are cut off by the interposed opaque body creating a shadow on the screen; the shadow is viewable through the screen by an audience or other observer(s) on the opposite side of the screen. The silhouette cast on the screen can be utilized for photography, puppet productions, stage shows, dancing performances, and the like.

The fascination with the unique projected moving shadow continues today, particularly for shadow dancing. Shadow dancing adds interest and entertainment to parties, clubs, events, photography and videography; yet the simple, casual set-up of a light source behind a happenstance screen provides indistinct and poorly lit shadows, limiting the enjoyment of the viewer and the quality of the images that may be obtained by photography or videography. A professional stage shadow dancing setup using a full-production stage with high-tech stage lighting can be designed and installed for major shows, but such a setup is too costly, too complex, and too bulky to be transportable or to be usable for private parties, events, or rental.

Currently no kit, set, or system is available that provides a portable, self-contained, and easily assembled shadow screen studio. Such a portable, reusable kit could be utilized for numerous applications by a variety of users; for example, such a kit would be highly desirable for the following purposes: rented for private parties; used for photography; used for videography; temporarily set up for an act at a club; utilized for shadow dancing contests; etc.

Accordingly, there is an established need for a convenient, easy-to-assemble, reusable, self-contained, portable shadow screen kit for assembling a shadow screen studio that can be rented or can be sold in kit form for professional use or for the general public.

### SUMMARY OF THE INVENTION

The present invention is directed to a self-contained, washable, portable, shadow screen kit that, when assembled into a shadow screen studio, allows a human body (or other opaque object) to cast a sharp, distinct shadow on the back of a taut screen that is viewable by an audience or observers from the front of the screen. The assembled shadow screen kit is particularly suited for shadow dancing, photography, or videography. The shadow screen kit is efficiently assembled and disassembled, easily transported between venues and stored between uses.

The shadow screen kit includes a generally rectangular side-and-back exterior enclosure (such as the enclosure frame and drapes of the first embodiment), a light source, a light support, and a front stretchable screen. The frame includes at least four corner upright posts supported by four bases and four top horizontal rods connecting the corner upright posts; the frame supports drapes to prevent light bleed. Preferably a lightweight ceiling, a mirror, and mirror stand can also be included for a sharper image.

An object of the present invention is to provide a shadow screen kit that is self-contained.

A further object of the present invention is to provide a shadow screen kit that is easy to assemble and disassemble.

Another object of the present invention is to provide a shadow screen kit that is easy to store when disassembled.

An additional object of the present invention is to provide a shadow screen kit that is easy to transport.

Another object of the present invention is to provide a shadow screen kit that provides a distinct shadow.

An additional object of the present invention is to provide a shadow screen kit that, when assembled into a shadow screen studio, is particularly suitable for shadow dancing.

A further object of the present invention is to provide a shadow screen kit that, when assembled, is usable for shadow photography and videography.

These and other objects, features, and advantages of the present invention will become more readily apparent from the attached drawings and from the detailed description of the preferred embodiments, which follow.

### BRIEF DESCRIPTION OF THE DRAWINGS

The preferred embodiments of the invention will hereinafter be described in conjunction with the appended drawings, provided to illustrate and not to limit the invention, where like designations denote like elements, and in which:

FIG. 1 is an interior perspective view showing the first preferred embodiment of the assembled shadow screen kit of the present invention being used for shadow dancing;

FIG. 2 is a perspective view showing the corner upright posts and bases of the frame of the first preferred embodiment of the shadow screen kit of the present invention;

FIG. 2A is a detail perspective view taken from circle 2A of FIG. 2 of the top of a corner upright post of the first preferred embodiment of the shadow screen kit of the present invention;

FIG. 2B is a detail perspective view taken from circle 2B of FIG. 2 of the bottom of a corner upright post illustrating an optional design aspect of the conduit retainers of the shadow screen kit of the present invention;

FIG. 3 is a perspective view showing the insertion of the front top horizontal post and of the bottom conduit into sleeves of the shadow screen of the first preferred embodiment of the shadow screen kit of the present invention;

FIG. 4A is a detailed perspective view taken from circle 4A of FIG. 3 of the first preferred embodiment of the shadow screen kit of the present invention;

FIG. 4B is a detailed perspective view taken from circle 4B of FIG. 3 of the first preferred embodiment of the shadow screen kit of the present invention;

FIG. 5 is a perspective view showing an exploded side-and-back exterior enclosure (having a frame and drapes) with the front shadow screen of the first preferred embodiment of the shadow screen kit of the present invention;

FIG. 6 is a rear view of the front screen of the first preferred embodiment of the shadow screen kit of the present invention;

FIG. 7 is an exploded top view of the top lightweight ceiling of the first preferred embodiment of the shadow screen kit of the present invention;

FIG. 8 is a side view of the individual pieces that form the mirror stand of the first preferred embodiment of the shadow screen kit of the present invention;

FIG. 9 is a front view illustrating the assembly of the screen of the second embodiment of the shadow screen kit of the present invention;

FIG. 10 is a front view illustrating the assembly of the screen of the second embodiment of the shadow screen kit of the present invention;

FIG. 11 is an exploded top view of the top lightweight ceiling of the second embodiment of the shadow screen kit of the present invention;

FIG. 12 is a perspective view showing a third embodiment of the shadow screen kit of the present invention assembled into a shadow screen studio and being used for shadow dancing;

FIG. 13 is a perspective view of the mirror and mirror stand of the fourth embodiment of the shadow screen kit of the present invention;

FIG. 14 is a perspective view of the mirror supported by the mirror stand of the fourth embodiment of the shadow screen kit of the present invention;

FIG. 15 is a perspective view of the side-and-back exterior enclosure and lightweight ceiling of the fourth embodiment of the shadow screen kit of the present invention;

FIG. 16 is a perspective view of the screen and side-and-back exterior enclosure with the lightweight ceiling of the fourth embodiment of the shadow screen kit of the present invention; and

FIG. 17 is an underside view of the ceiling interior of a fifth embodiment of the shadow screen kit of the present invention.

Like reference numerals refer to like parts throughout the several views of the drawings.

### DETAILED DESCRIPTION OF THE PREFERRED EMBODIMENTS

Shown throughout the figures, the present invention is directed toward a self-contained shadow screen kit for forming a shadow screen studio that allows the creation of a well-defined shadow, while being easy to assemble, disassemble, transport, store, and clean. The assembled shadow screen studio formed from the shadow screen kit allows a human body (or other opaque object) that is positioned between the mirror and a generally taut screen to cast a sharp, distinct shadow on the back of the screen, with the shadow viewable by an audience (or other observer, such as a photographer) from the front of the screen. The assembled shadow screen kit provides for still shadow production or novel moving shadow production, being particularly suited for shadow dancing, photography, or videography.

The portable shadow screen kit can be easily moved from one event or venue to another; it can be offered for rental for parties or other occasions; it can be sold as a kit; it can be utilized in a theatrical or stage production; it can be operated to provide entertainment for children's parties; it can be employed to augment a mobile disc jockey's equipment providing an entertaining enhancement to his or her mobile sound system; it allows intriguing photographs and videos to be produced. These convenient and versatile uses take advantage of the ease with which the kit can be erected and dismantled; the compactness of the disassembled pieces; the reasonable weight for manual lifting and moving of the disassembled kit; the ability to clean any element of the shadow screen kit; and the sharp, distinct shadow produced.

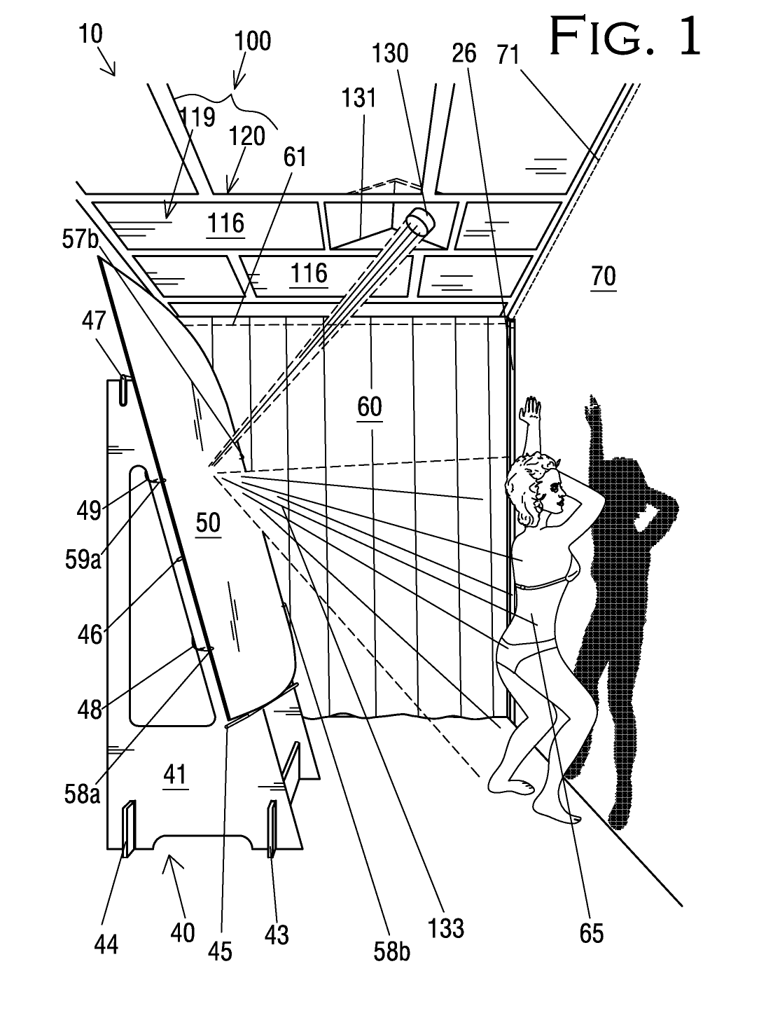

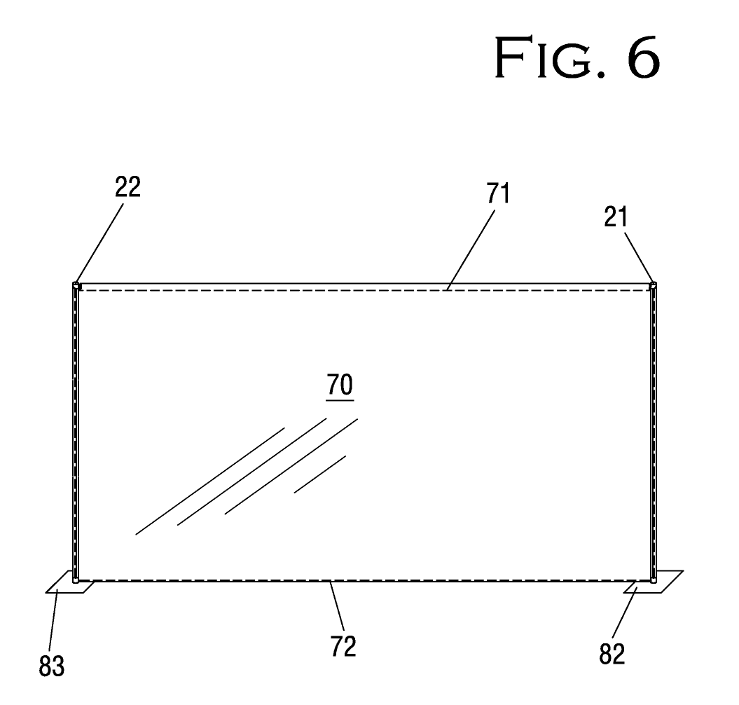

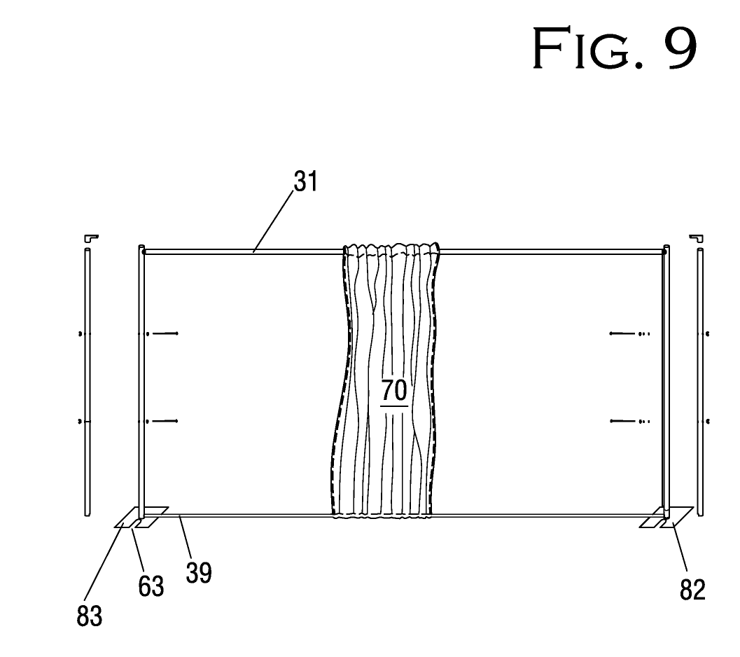

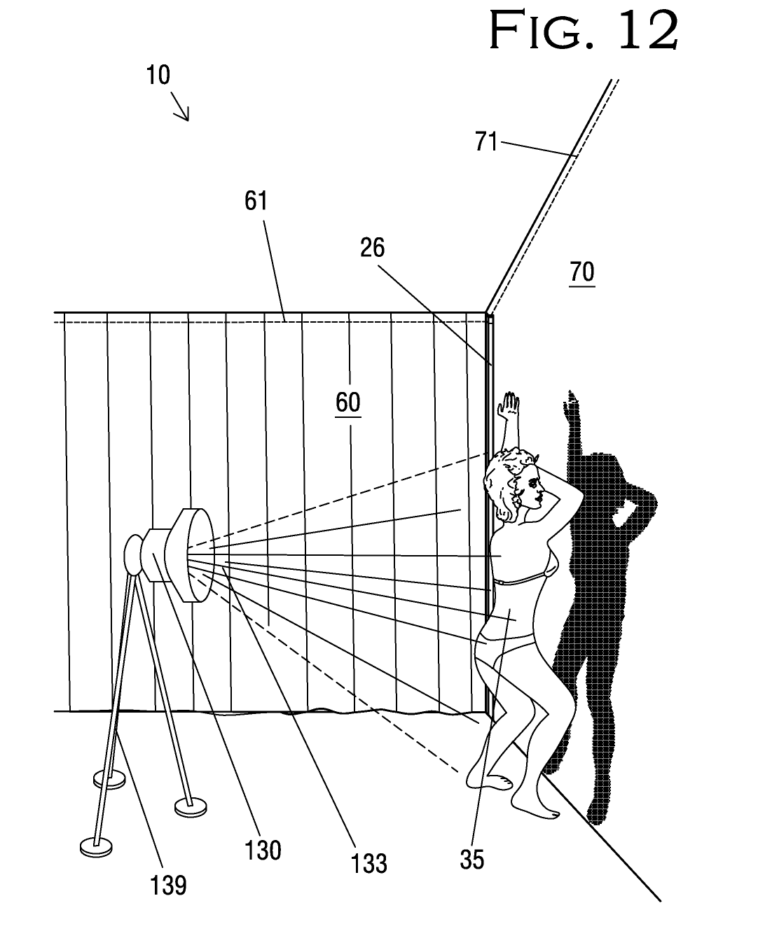

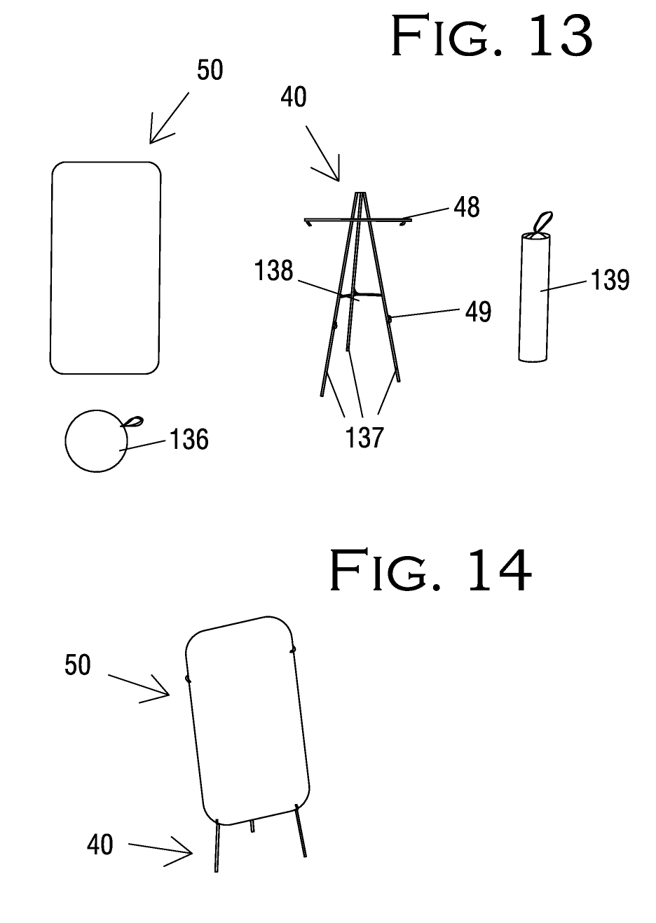

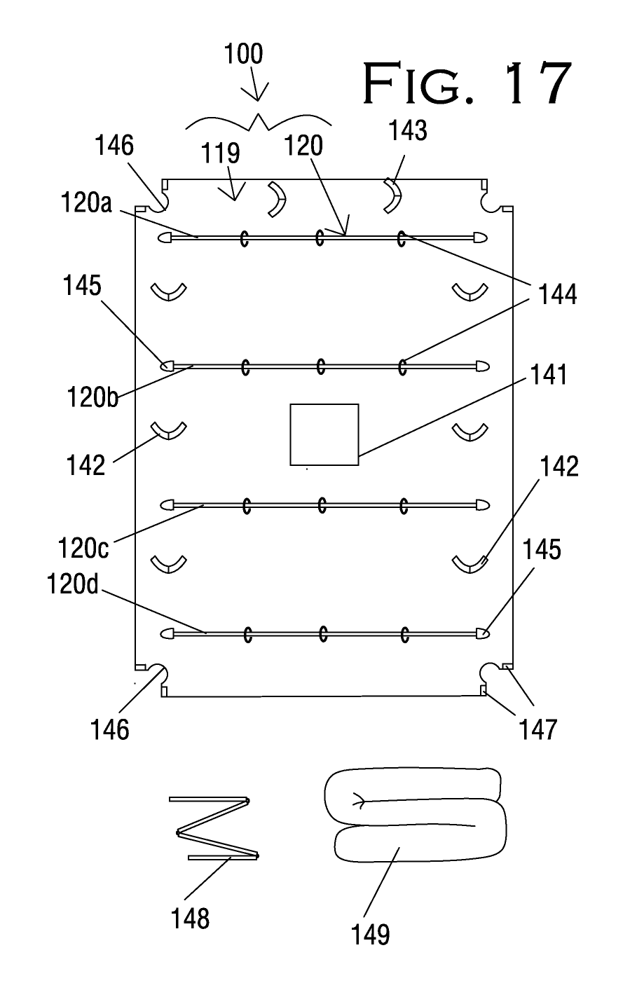

Five embodiments are presented, a first embodiment, (FIG. 1 to FIG. 8), a second preferred embodiment (FIG. 9 to FIG. 11), a third simplified embodiment (FIG. 12), a fourth embodiment (FIG. 13 to FIG. 16), and a fifth embodiment (FIG. 17).

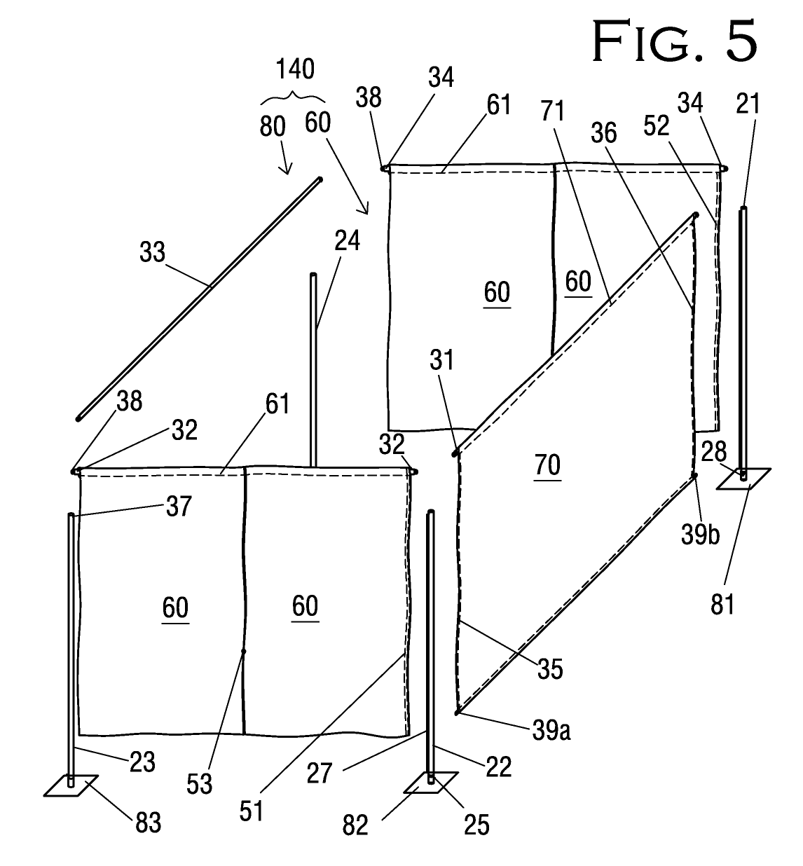

Referring now to FIG. 1, the assembled shadow screen kit, shown generally as reference number 10, is illustrated in accordance with a first embodiment of the present invention, as being utilized for shadow dancing. As shown, the shadow screen kit 10 generally includes a front screen 70, a light source 130, a generally rectangular side-and-back exterior enclosure 140 (FIG. 5). The side-and-back exterior enclosure 140 of the first embodiment includes enclosure frame 80, and drapes 60 positioned and configured to prevent light bleed. Preferably a lightweight ceiling 100, a mirror 50, and mirror stand 40 are also included.

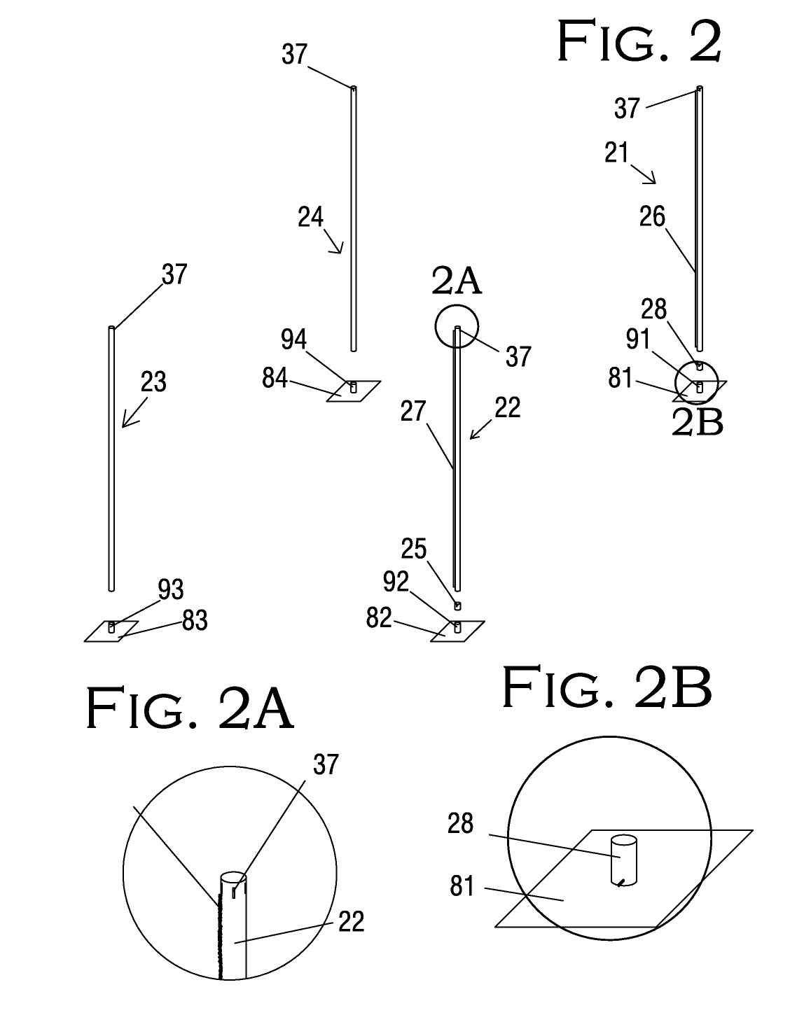

Enclosure frame 80 (FIG. 5) includes the framework structure for the four side walls of the assembled shadow screen kit and provides a support for the lightweight ceiling 100 and drapes 60. Enclosure frame 80 is configured to be easily disassembled, packed, transported, and stored. The frame 80 may be formed of conventional components, as may be known or become known in the art, such as the standard theatrical pipe that is configured to support standard theatrical blackout drapes 60, as shown in the first embodiment. FIG. 2 to FIG. 6 illustrate an exemplary method of assembly of enclosure frame 80.

Best seen in FIG. 2 and FIG. 5, frame 80 includes four corner upright posts (21, 22, 23, 24) supported by four bases (81, 82, 83, 84) and four top horizontal rods (31, 32, 33, 34) connecting at the top ends of the upright posts (21, 22, 23, 24). Each of the bases 81, 82, 83, 84 have a wide, flat foundation for stability and an integrally formed upright post receiver 91, 92, 93, 94 (FIG. 2), respectively.

The upright post receivers 91, 92, 93, 94 are sized and configured to receive, support, and hold the lower end of one of the four corner upright posts 21, 22, 23, 24, respectively. Preferably upright post receivers 91, 92, 93, 94 are of the pin type; each base is configured with one pin-type receiver 91, 92, 93, 94 over which the lower end of one of the four corner upright posts 21, 22, 23, 24 is slipped. Alternatively, the upright post receivers 91, 92, 93, 94 may be of the screw-in type; in this case, the upright post receivers 91, 92, 93, 94 are configured with threads and lower ends of each of the four corner upright posts 21, 22, 23, 24 are configured with complementary threads. As a further alternative, the upright post receivers 91, 92, 93, 94 can be of the sleeve type; in this case each of the bases 81, 82, 83, 84 is configured with a sleeve into which one of the four corner upright posts 21, 22, 23, 24 is slipped. Optionally (not shown), a bolt or latch may further secure the four corner upright posts 21, 22, 23, 24 to the upright post receivers 91, 92, 93, 94.

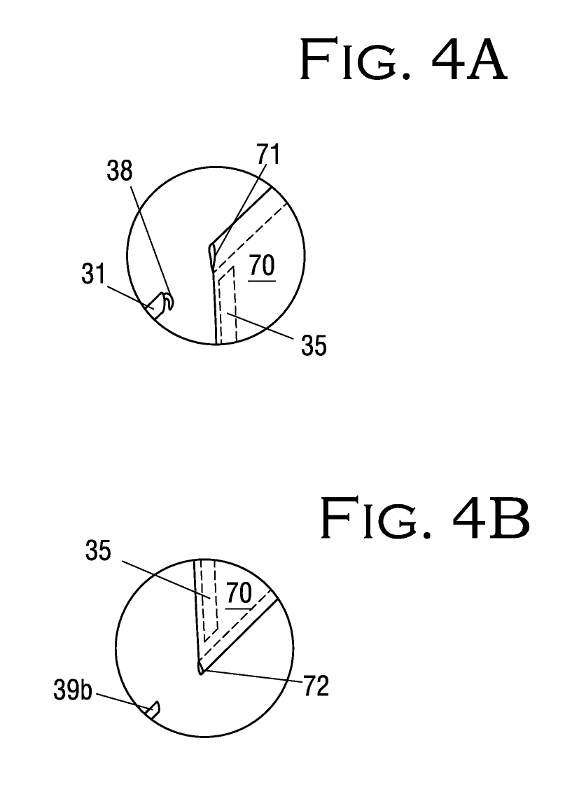

The four corner uprights 21, 22, 23, 24 are configured to support the four top horizontal rods 31, 32, 33, 34 (FIG. 5), which serve as drape poles. A standard support connection is illustrated with a hook 38 (FIG. 4A) disposed on each end of the four top horizontal rods 31, 32, 33, 34 and with slots 37 (FIG. 2A) disposed on the upper end of each of the four corner upright posts 21, 22, 23, 24 configured to receive hooks 38. The hooks 38 slip easily and securely into the slots 37. Alternatively, other attachment mechanisms and support connections, as may be known or become known in the art, may be utilized.

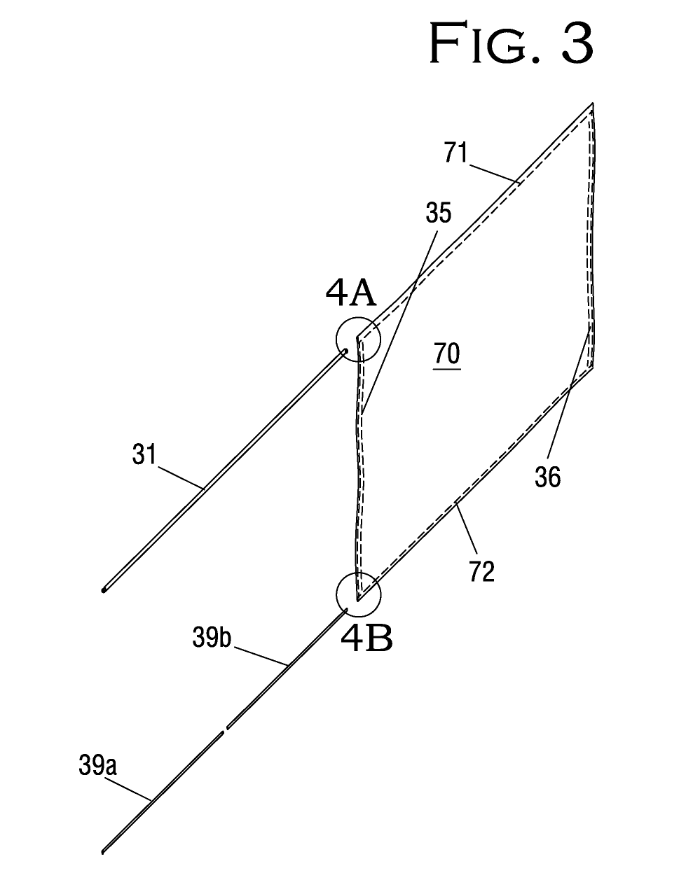

The four corner uprights 21, 22, 23, 24 are preferably of fixed height, but may alternatively be telescopic and adjustable for variable heights. They may optionally include a plug or end cap (not shown) at the top for a more finished appearance. The front corner uprights 21, 22 are each configured with a strip 26, 27 (FIG. 2, FIG. 2A) of complementary hook-and-loop-type fastener, such as is sold under the trademark Velcro®, for attachment to the strip 35, 36 (FIG. 3) of complementary hook-and-loop-type fastener disposed along the side edges of screen 70.

Bases 81, 82, 83, 84 may be further configured with conventional slots 63 (FIG. 9) to allow more compact stacking, if desired.

Preferably the four corner upright posts 21, 22, 23, 24, the four bases 81, 82, 83, 84 and four top horizontal rods 31, 32, 33, 34 are formed of a light, durable material, most preferably aluminum. Alternatively, the bases 81, 82, 83, 84 may be formed of steel or cast iron for additional weight and stability. The four top horizontal rods 31, 32, 33, 34 are preferably extendable or telescopic for convenience of transport and storage; they may include button stops or clamps (not shown) to secure the post at the desired length; most preferably the top horizontal rods extend from six feet long to eight feet long (side posts 32, 34) or to ten feet long (front and back posts 31, 33).

Drapes 60 are provided to prevent light bleed. Preferably drapes 60 are standard blackout drapes configured with an upper sleeve 61 (FIG. 5), for receiving rear top horizontal rod 33, side top horizontal rod 32, or side top horizontal rod 34. Preferably two four-foot by eight-foot blackout drapes are slid onto side top horizontal rod 32 and two additional four-foot by eight-foot blackout drapes 60 are slid onto side top horizontal rod 34. If the shadow screen is to be free-standing, preferably three additional four-foot by eight-foot blackout drapes 60 are slid onto rear top horizontal rod 33; if the back of the assembled shadow screen kit will be placed against a wall, the back drapes are unnecessary. To further prevent light bleed, preferably the forward one of the two drapes 60 slid onto each side top horizontal rod 32, 34 is configured with a strip 51, 52 (FIG. 5) of hook-and-loop fastener, which is configured to be attached to a strip 35, 35 (FIG. 3, FIG. 5) of complementary hook-and-loop fastener disposed along the side edge of screen 70.

Conduit retainers 25, 28 (FIG. 2) are disposed on the post receivers 92, 91 of front bases 82, 81, respectively. Each conduit retainer 25, 28 is configured to receive, support, and hold one end of a conduit 39 (FIG. 3). The conduit retainers 25, 28 are preferably separate sleeves (as shown) which are manually slipped over the upright pin-type post receiver 91, 92 of the front bases 81, 82, respectively. Alternatively, they may be formed integrally (not shown) with front bases 81, 82. Conduit retainers 25, 28 may be further secured by mechanical means, such as a bolt or latch, if desired.

As illustrated in FIG. 3, screen 70 is configured with both a top sleeve 71 configured to receive top horizontal rod 31 and a bottom sleeve 72 configured to receive conduit 39. Preferably, the top sleeve 71 is approximately two inches in width and the bottom sleeve 72 is approximately one inch in width.

Conduit 39 (FIG. 3, FIG. 5) is a post, tube, or bar configured to removably attach to conduit retainer 25, 28. Preferably, for convenience of transport and storage, conduit 39 may be formed in two separate pieces, as shown, (39a, 39b, FIG. 3) that are configured with complementary threads and are screwed together to achieve the full length. Alternatively, conduit 39 may be an extendable or telescopic post (not shown) or, less preferably, a solid post. Conduit 39 may be of a similar diameter to the top horizontal rods 31, 32, 33, 34, but is preferably somewhat smaller in diameter.

Screen 70 is formed of a fabric that allows a shadow that is produced on the back of screen 70 to be viewable from the front of screen 70. The fabric of screen 70 is preferably stretchable, having the ability to be stretched repeatedly and still snap back substantially to its original shape and length, as the shadow screen kit is assembled and disassembled. Most preferably the fabric of screen 70 is a white spandex blend fabric, such as a nylon-spandex, rayon-spandex, silk-spandex, cotton-spandex, polyester-spandex, or the like. However, for specific applications and/or special effects, a fabric having any of a variety of colors, textures, designs, or other fabric characteristics may be utilized to set a mood or to deliver a particular impact. For example, a fiber-optic embedded screen could be used to provide a twinkling star effect.

In the first embodiment, a strip of hook-and-loop-type fastener 35, 36 (FIG. 3, FIG. 4A, FIG. 4B) is preferably disposed along the right and the left side edges of screen 70, allowing the edges of the screen 70 to be releasably attached to front corner uprights 21, 22.

The screen 70 is attached to the front of enclosure frame 80 in a generally stretched or taut manner. The top horizontal rod 31 disposed within top sleeve 71 and conduit 39 disposed within bottom sleeve 72 serve to stretch the screen vertically. Two exemplary methods of horizontal screen attachment are illustrated in the first and second embodiments, but other methods of attachment that achieve a similar stretched or taut screen are within the scope of the invention. In the first embodiment, to stretch the screen horizontally, the side edges of screen 70 are wrapped around the front corner uprights 21, 22, with the strips 35, 36 of hook-and-loop-type fastener disposed along the edges of screen 70 engaged with the complementary strips 26, 27 (FIG. 2) of hook-and-loop-type fastener disposed on the rearward-facing surface of front corner uprights 21, 22.

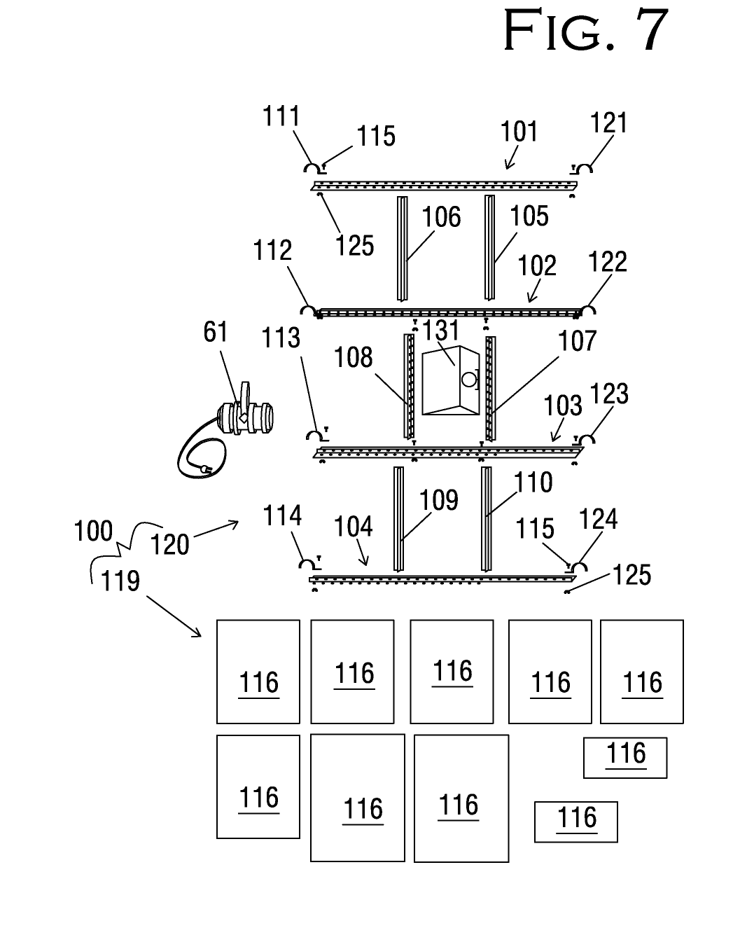

A top lightweight ceiling 100 (FIG. 1) is supported by enclosure frame 80 at a sufficient height for the intended use; for use as a shadow dancing screen studio, such a sufficient height is approximately eight to nine feet. The lightweight ceiling 100 comprises a lightweight darkening structure 119 (FIG. 1, FIG. 7) supported by a ceiling frame 120 (FIG. 7). The ceiling frame 120 provides a framework to support the light source 130, light hood 131, and ceiling darkening structure 119. The lightweight ceiling darkening structure 119 may be any structure as may be known or become known in the art that can be supported by the ceiling frame 120 while serving to darken the interior of the shadow screen. For example, the darkening structure may be as a lightweight fabric rolled onto the ceiling frame 120 (as illustrated in FIG. 17) or may be formed of more substantial, rigid panels 116 (as illustrated in FIG. 7) that are supported by the ceiling frame 120.

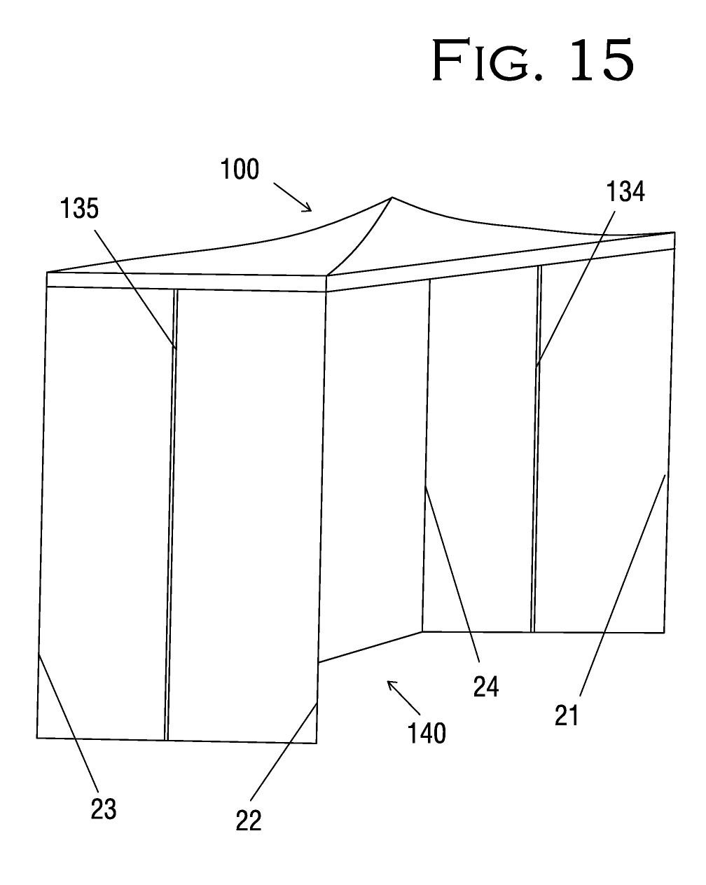

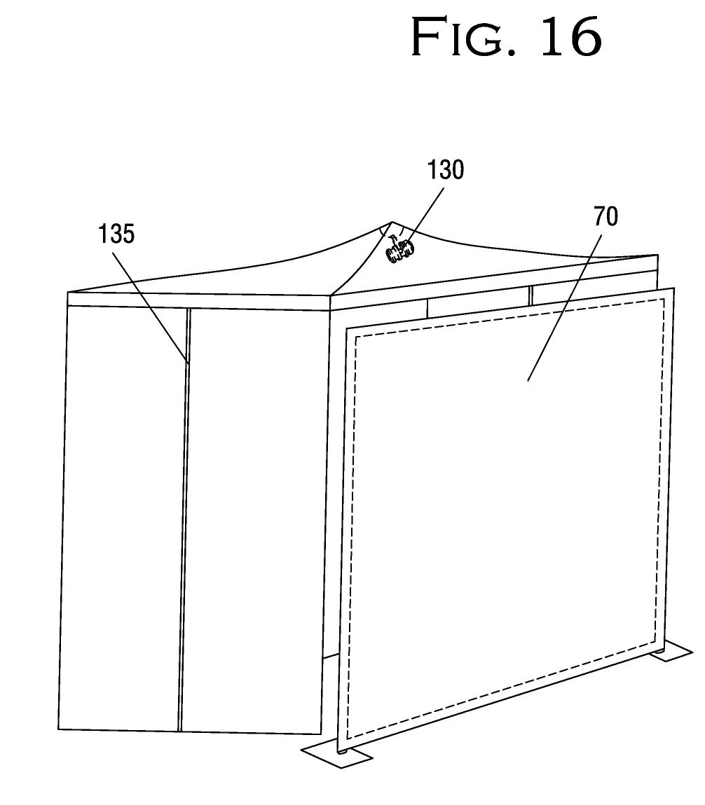

The ceiling frame 120 may be any of a variety of conventional structures as may be known or become known in the art (either flat as in FIG. 1 or peaked as in FIG. 15) that can serve as a foundation and bear the weight of the lightweight darkening structure 119, maintaining the darkening structure 119 in position as a ceiling covering to minimize light bleed. Exemplary ceiling frames 120 are illustrated in the first and second embodiment as frame components connected to form the ceiling frame 120 (cross members 101, 102, 103, 104 with connecting members 105, 106, 107, 108, 109, 110) and are illustrated in the fifth embodiment (FIG. 17) as fiber, resin, or aluminum tubes joined by ferrule connectors (either internal or external) and optionally corded with shock cord for convenience of assembly.

Turning now to the ceiling frame 120 and ceiling darkening structure 119 of the first embodiment, as shown in detail in FIG. 7, the ceiling frame 120 of the lightweight ceiling 100 includes four cross members 101, 102, 103, 104 and six connecting members 105, 106, 107, 108, 109, 110.

Both ends of each cross member 101, 102, 103, 104 are configured with a hanger (111 and 121, 112 and 122, 113 and 123, 114 and 124, respectively). The cross members 101, 102, 103, 104 (with their associated hangers) are sized to reach from the front to the rear of enclosure frame 80. The hangers 111, 121, 112, 122, 113, 123, 114, 124 are sized and configured to removably attach to the top horizontal rods 31, 32, 33, 34 (FIG. 5) (by hooking over the top and hanging suspended in this manner).

Preferably the standard pipe and drape semicircular hanger, as illustrated, is utilized. The hangers 111, 121, 112, 122, 113, 123, 114, 124 are preferably secured to cross members 101, 102, 103, 104 via conventional machine screws 115 with wing nuts 125 for convenient hand tightening (as shown before installation on cross members 101, 103, 104 and after installation on cross member 102) or such other fastening tool as may be known or become known in the art.

The central connecting members 107, 108 are also preferably secured to cross members 102, 103 via conventional machine screws 115 with wing nuts 125 or such other fastening tool as may be known or become known in the art.

The central connecting members 107, 108 and the inner cross members 102, 103 preferably comprise elongated T-shaped, metal angles, as illustrated. Most preferably, the T-shaped angles comprise perforated angles with a grid angle riveted onto each. However, non-perforated metal, preferably with machine screw holes predrilled at designated locations, can be used and is within the scope of the invention.

The outer connecting members 105, 106, 109, 110 are preferably formed of elongated T-shaped metal angles, as illustrated. The outer cross members 102, 103 are preferably formed of elongated perforated L-shaped metal angles.

When in use, as shown in the first embodiment of FIG. 1, the mirror 50, supported by mirror stand 40, is positioned in the rear of the area defined within enclosure frame 80 to receive the light 133 from light source 130 and to reflect the light 133 to allow the dancer (or other opaque object) to create a shadow on screen 70.

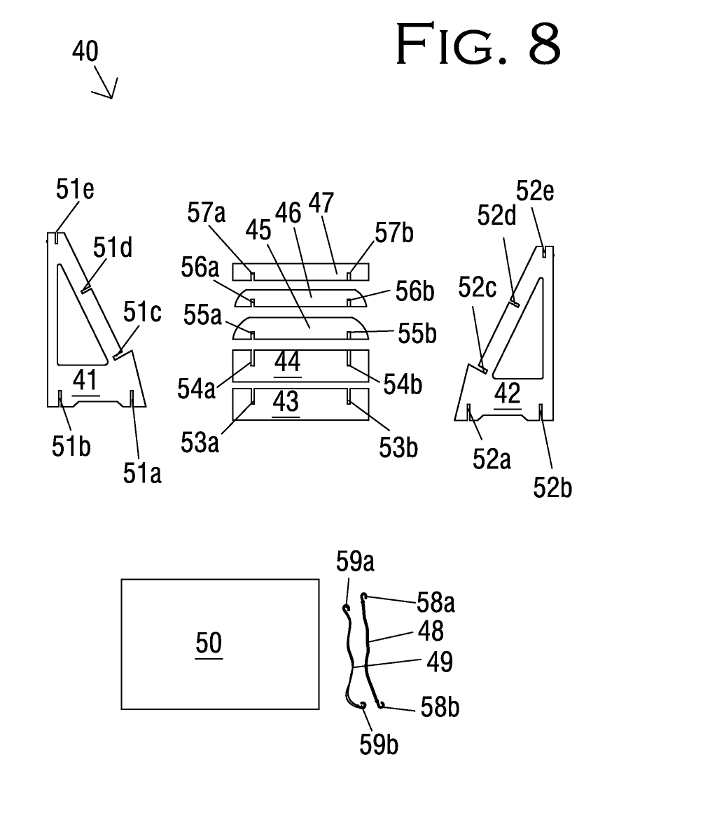

As illustrated in FIG. 8, the exemplary mirror stand 40 includes seven interlocking panels that can be quickly, manually assembled at the location of use to form an angled stand for holding and supporting mirror 50. A first side panel 41 and a second side panel 42 are held together by base panels 43, 44, top panel 47, mid panel 46, and mirror-support panel 45. Less preferably, a conventionally available mirror stand may be used.

Mirror 50 is preferably a mirrored acrylic sheet, such as is sold under the trademark Plexiglas®, but other types of mirrors and light reflectors (including plastic sheet mirrors, mirrored fabrics, and other generally lightweight reflectors, as shown in the fourth embodiment of FIG. 13 and the fifth embodiment of FIG. 17) are within the scope of the invention. Most preferably mirror 50 is a one-eighth inch by four foot by six foot Plexiglas® mirror. The mirror 50 is held to mirror stand 40 by mirror retainers 48, 49; any of a variety of mirror retainers 48, 49, as may be known or become known in the art, are within the scope of the invention. For example, the mirror retainers 48, 49 illustrated in the first embodiment of FIG. 1, are configured with mirror-engaging hooks 58a, 58b, 59a, 59b to removably attach to the sides of mirror 50. Mirror retainers 48, 49 are preferably tie-down straps, such as are commonly sold under the trademark Bungee® straps and are commonly formed of rubber or stretch cord. Mirror retainers 48, 49 are approximately three feet long. The mirror retainers 48, 49 serve both to retain the mirror 50 to the mirror stand 40 and to bend the mirror 50 to the sides of screen 70.

As shown in FIG. 1, the mirror-engaging hooks 58a, 59a are manually secured to a first side edge of mirror 50, then the mirror retainers 48, 49 are run behind mirror 50 through mirror stand 40, and then the opposing mirror-engaging hooks 58b, 59b are engaged to the second side edge of mirror 50.

To assemble the shadow screen kit of the first embodiment, the bases 81, 82, 83, 84 are positioned on the floor at approximately the corners of the enclosure frame 80 to be formed, as in FIG. 2. For example to form a frame 80 approximately six feet deep by ten feet wide, the front base 81 and front base 82 are placed roughly 6 six feet in front of the rear bases 83, 84; front base 81 and front base 82 are placed roughly ten feet apart; rear base 83 and rear base 84 are placed roughly ten feet apart. If conduit retainers 25, 28 are of the sleeve-type, they are slid onto front base 81 and front base 82.

The rear corner upright posts 23, 24 are placed onto the post receivers 93, 94 of the rear bases 83, 84. The front corner upright posts 21, 22 are placed onto the post receivers 91, 92 of the front bases 81, 82 with the hook-and-loop-type fastener strip 26, 27 facing backward into the interior area of the enclosure frame 80.

The front top horizontal rod 31 is fed through the top sleeve 71 (FIG. 3, FIG. 4A) of screen 70. The rod 31 is hung with the complementary hook-and-loop fastener strip 35, 36 facing inwards, by engaging the hooks 38 on the opposing ends of front top horizontal rod 31 with the slots of front corner upright posts 21, 22. After joining the two pieces of conduit 39 (or extending it, if conduit 39 is provided as telescoping), the conduit 39 is slid into the lower sleeve 72. The opposing ends of conduit 39 are then engaged with the conduit retainers 25, 28, preferably with a set screw tightened to secure conduit 39; thus the screen 70 is stretched vertically.

Then, each side of the screen 70 (configured with the hook-and-loop-type fastener strip 35, 36) is pulled around the front of the nearby upright post 22, 21 and pulled to the back of the upright post 22, 21. At the back, each hook-and-loop-type fastener strip 35, 36 is releasably engaged with each hook-and-loop-type fastener strip 27, 26 disposed along the length of the upright post 22, 21, respectively.

To form the sides of the assembled shadow screen kit, two drapes 60 are unfolded and placed on each of the side top horizontal rods 32, 34 (by feeding the posts 32, 34 through the upper drapery sleeves 61). The forward drape 60 on each of the side top horizontal rods 32, 34 is configured with a strip of hook-and-loop-type fastener 51, 52 (FIG. 5), which is engaged with a complementary strip of hook-and-loop-type fastener on the side edges of screen 70. If telescoping horizontal rods 32, 34 are being used, they are extended.

Then the horizontal rods 32, 34 are connected to the upright posts 21, 22, 23, 24, as illustrated in FIG. 5. The hooks 38 on the opposing ends of the side top horizontal rod 32 are placed into the slots 37 of corner upright posts 22, 23; with the hooks 38 of the side top horizontal 34 similarly placed into the slots 37 of corner upright posts 21, 24. Pinch clips 53 (or, optionally, complementary strips of hook-and-loop-type fastener or other non-permanent attachment devices) may be used to close the opening between the two drapes on horizontal rods 32, 34, if desired.

Optionally, if the assembled shadow screen kit is freestanding, three additional drapes 60 may be placed on the rear top horizontal rod 33. The hooks 38 on each opposing end of rear top horizontal rod 33 are engaged in the slots of rear corner upright posts 23, 24.

The top lightweight ceiling 100 is then assembled, as follows. To support the light source 130 and light hood 131, the central grid ceiling frame 120 is preferably assembled first. Cross member 102 and cross member 103 are positioned with the perforated right angles facing each other. Machine screws 115 with wing nuts 125 are used to attach the hangers 112, 122 to the opposing ends of the horizontal section of cross member 102 and used to attach the hangers 113, 123 to the opposing ends of the horizontal section of cross member 103. Hanger 112 is placed over top horizontal rod 33 with hanger 122 placed over top horizontal rod 33 allowing cross member 102 to extend between the two horizontal rods 31, 33. Similarly hanger 113 is placed over top horizontal rod 33 with hanger 123 placed over top horizontal rod 33 allowing cross member 103 to extend between the two horizontal rods 31, 33. Cross member 102 is positioned approximately three feet from cross member 103.

Connecting members 107 and 108 are attached between the two cross members 102 and 103. Connecting member 107 is positioned approximately two feet from the front top horizontal rod 31 and is attached using machine screws 115 with wing nuts 125. Connecting member 108 is preferably positioned 19½ inches rearward of connecting member 107 and attached using machine screws 115 with wing nuts 125. The created light support assembly is adjusted to the center of enclosure frame 80, if not already positioned centrally.

The two outer cross members 101, 104 are added to the central light support assembly to complete the top lightweight ceiling 100, forming a grid defining open inner spaces configured to receive the ceiling panels 116. Hangers 111, 121 and hangers 114, 124 are installed on opposing ends of cross members 101 and 104, respectively. Connecting members 109 and 110 are positioned between cross member 104 and cross member 103, spaced so as to provide support, and are then attached using machine screws 115 with wing nuts 125. Similarly, connecting members 105, 106 are attached between cross member 101 and 102.

To prevent light bleed from the corner of the screen, optionally two twelve-inch-wide blackout drapes (not shown) may be installed at the front corners of the enclosure frame 80, on either side of screen 70.

Clips are preferably provided to be used as needed to secure the blackout drapes.

Light source 130 is configured to shine light on the back of screen 70, either directly or indirectly. In the first and second embodiments, the light 133 is first directed onto mirror 50, which reflects it to shine onto the back of the screen 70. In the third embodiment, the light 133 shines directly onto the back of the screen, without mirror 50.

To install the light source 130 in the lightweight ceiling 100, a bulb of the light source 130 is inserted in the par can 61, with the par can installed in the light hood 131 and secured with a bolt and wing nut. The light source 130 is then lifted into place, supported by the light support framework (cross members 102, 103 and connecting members 107, 108). The power cord is run over the top and down the back of enclosure frame 80 to an available power outlet.

After completion of the top lightweight ceiling 100, the ceiling panels 116 are lifted and set in place.

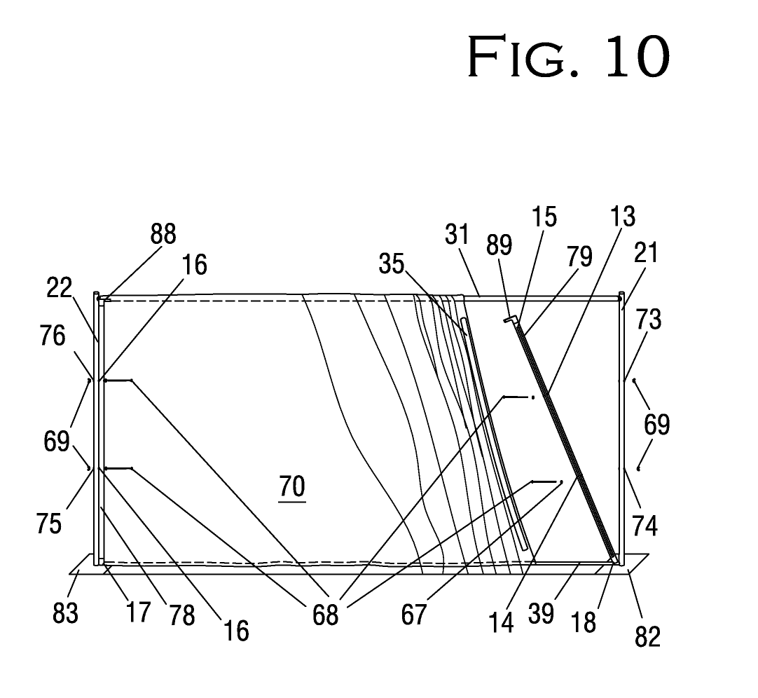

To assemble the mirror stand 40 (FIG. 10), which is to be placed in the interior area defined by the assembled enclosure frame 80, the two large pieces, first side panel 41 and second side panel 42, are joined by base panel 43 and base panel 44. Then the top panel 47, mid panel 46, and mirror-support panel 45 are installed between the side panels 41, 42.

The mirror is positioned on mirror stand 40 so as to rest upon mirror-support panel 45. The mirror is secured by mirror retainers 48, 49. As shown in FIG. 1, the mirror-engaging hook 58a, is manually secured to a first side edge of mirror 50; then the mirror retainer 48 is run behind mirror 50 through mirror stand 40; then the opposing mirror-engaging hook 58b is engaged to the second side edge of mirror 50. The second mirror retainer 49 is installed similarly, with one mirror retainer positioned higher and one lower, so as to provide support for the mirror 50. Preferably the mirror retainers 48, 49 are sized to bend the mirror 50 into a slightly convex shape to spread the light 133 to the sides of the screen 70.

The mirror stand 40 with the attached mirror 50 is then placed near the center rear inside assembled enclosure frame 80.

Light source 130 is focused toward mirror 50. To get the optimum effect from the light source 130, the angle can be varied. Though the blackout drapery is treated for heat resistance, for safety, care should be taken to prevent the light source 130 from coming into contact with any elements except the metal light hood 131.

Disassembly is performed by reversing the above steps. The individual elements (disassembled pieces and folded blackout drapery) of the shadow screen kit 10 can be packed for transport in a relatively compact area, facilitating moving to a new event or function. This straightforward assembly and disassembly of the shadow screen kit 10 allows convenient rental, transport, and storage in kit form. As all of the individual elements are washable, if one or more becomes soiled, it is easy to wash or clean it before the next use.

FIG. 9 to FIG. 11 illustrate a second exemplary embodiment of the shadow screen kit 10 of the present invention. The second embodiment of the shadow screen kit 10 is structured in a similar manner to the first exemplary embodiment of FIG. 1 to FIG. 8; however, options for the screen 70 attachment and for the top lightweight ceiling 100 are provided.

In the second embodiment, to secure the screen 70 in a stretched manner, front corner uprights 21, 22 are configured with screw-receiving holes 73, 74, 75, 76 (FIG. 10) for attaching a separate interior upright pole 78, 79. The interior upright poles 78, 79 are each configured with a lower notch 17, 18 at the bottom and a strip of hook-and-loop-type fastener 15 along the side. Elbows 88, 89 are sized and configured to slide onto the tops of interior upright poles 78, 79. The elbows 88, 89 have an open top configured to receive top horizontal rod 31.

The elbows 88, 89 are slidingly engaged upon the tops of interior upright poles 78, 79, with the open end facing inwardly, as illustrated. Tapping of elbows 88, 89 may be necessary to fully seat the elbows 88, 89 onto interior upright poles 78, 79.

In assembling the shadow screen kit of the second embodiment, the front top horizontal rod 31 is slid into the upper two inch sleeve 71, with the fabric bunched in the center, as shown in FIG. 9. The rod 31 is hung with the complementary hook-and-loop fastener facing inwards, by engaging the hooks 38 on the opposing ends of front top horizontal rod 31 with the slots of front corner upright posts 21, 22. The conduit 39 is slid into the lower sleeve 72.

Elbows 88, 89 are slidingly engaged upon the tops of interior upright poles 78, 79, with the open end facing inwardly, as illustrated. As shown in FIG. 10, each interior upright pole 78, 79 is then installed to stretch the screen from top to bottom. The notch 18 (or 17) of the interior upright pole 79 (or 78) is placed over conduit 39, with the upper end of interior upright pole 78 (or 79) and attached elbow 89 leaned inward, then elbow 89 (or 88) is brought upward to cup the lower portion of the front top horizontal rod 32. Then the opposing interior upright pole 78 or 79 is installed. Carriage bolts 68, washers 67, and wing nuts 69 are loosely installed in holes 13, 14, 16, 17 to hold interior upright poles 78, 79 loosely to front corner uprights 22, 21, respectively. Then the procedure is repeated with the opposing interior upright pole 78 (or 79).

Then standing on the inside of screen 79, the fabric is slid to one side and pulled around the front of the interior upright pole 78 (or 79). Reaching between the interior upright pole 78 (or 79) and the front corner upright 22 (or 21), an edge of the fabric is pulled back between the interior upright pole 78 (or 79) and the front corner upright 22 (or 21). The fabric will bunch slightly around carriage bolts 68. Then attach the strip of hook-and-loop-type fastener on the screen 70 to the complementary strip of hook-and-loop-type fastener on the interior upright pole 78 (or 79). Then the wing nuts 69 are tightened. The procedure is repeated with the opposing interior upright pole 78 (or 79).

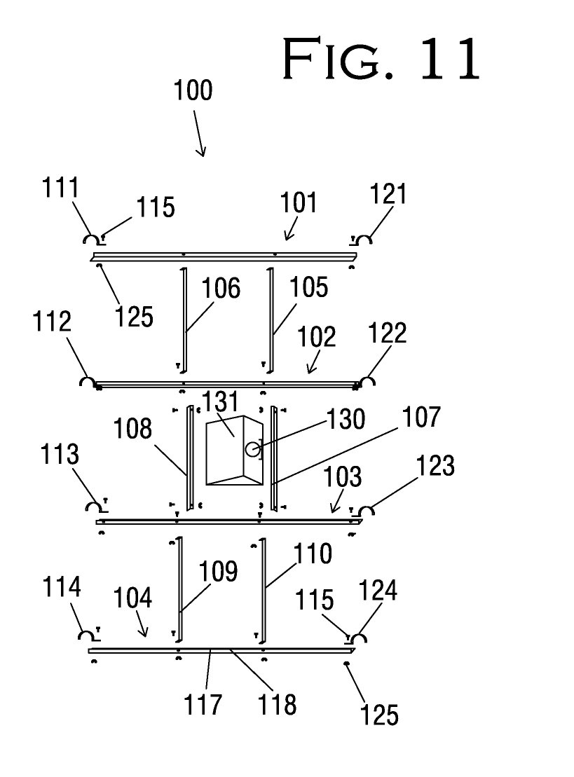

Illustrated in the second embodiment of FIG. 11 are optional types of cross members 101, 102, 103, 104 and of connecting members 105, 106, 107, 108, 109, 110. Cross members 101, 102, 103, 104 and connecting members 105, 106, 107, 108, 109, 110 are illustrated as non-perforated metal strips, having pre-drilled holes in the required places to receive screws 115.

Outer connecting members 105, 106, 109, 110 are each formed of a single flat metal strip, with each end of the flat metal strip bent at a right angle to allow attachment to a cross member via conventional machine screws 115 with wing nuts 125. Central connecting members 107, 108 are formed of a right angle (or L-shaped) metal strip.

As an additional option, the top darkening structure 119 may comprise top blackout drapes 60 (instead of the pre-cut ceiling panels 116 of the first embodiment). If ceiling drapes are used, they are installed over the top of the ceiling frame 120 of lightweight ceiling 100. A first top blackout drape is laid from front to back, over connecting members 109, 110 and cross members 104, 103. A second top blackout drape is laid over connecting members 105, 106 and cross members 101, 102. A third top blackout drape configured with a center cutout is laid over connecting members 107, 108 and cross members 102, 103, with the cutout positioned to receive the light hood and light source. For a finished appearance, preferably a small overhang from each of the top blackout drapes is left over the front of screen 70, covering the top horizontal rod 31 and top sleeve 71 of screen 70.

FIG. 12 illustrates a simplified embodiment, without a mirror 50, mirror stand 40 or lightweight ceiling 100. The light source 130 is supported by light support 139.

FIG. 13 illustrates a collapsible light reflector mirror 50 of a fourth embodiment. The collapsible mirror 50 of the fourth embodiment is preferably a lightweight reflective fabric (such as a silver fabric or Mylar® material) that can be collapsed for storage. The mirror 50 of the fourth embodiment is preferably of a spring-wire design that can collapse, so may be stored or transported in a mirror bag 136.

FIG. 13 further illustrates an exemplary collapsible mirror stand 40 of the fourth embodiment. The collapsible mirror stand 40 of the fourth embodiment is a tripod-type stand having legs 137 with one or more intersecting bars 138 to provide stability. The mirror retainers 48, 49 are configured to removably attach to the sides of mirror 50. The collapsible tripod-type mirror stand 40 of the fourth embodiment is preferably configured to collapse into a stand storage bag 139 for storage and transport.

FIG. 14 illustrates the collapsible light reflector mirror 50 of the fourth embodiment positioned on the collapsible mirror stand of the fourth embodiment.

The generally rectangular exterior side and back enclosure 140 with an integral lightweight ceiling 100 of the fourth embodiment is illustrated in FIG. 15. The side-and-back exterior enclosure 140 with integral lightweight ceiling 100 of the fourth embodiment may be a tent or tent-like structure, such as a conventionally available pop-up party tent, preferably with black or dark walls. The pop-up party tent is sufficiently tall to allow dancing within, and may be approximately ten feet wide by ten feet long by eight or nine feet tall. One or more zippers 134, 135 disposed on one or more of the sides of exterior enclosure 140 are preferably provided to allow convenient access by the dancer into the interior of the shadow screen studio formed by the shadow screen kit 10.

As shown in FIG. 16, the screen 70 of the fourth embodiment is free-standing. When in use, it is positioned adjacent to the side-and-back exterior enclosure 140 in a close-fitting placement (not shown) to enclose or block off the front of the shadow screen studio. Light source 130 may be suspended from a light support, such as the bracing in the integral lightweight ceiling 100.

FIG. 17 is an underside view of the ceiling interior of the fifth embodiment of the shadow screen kit 10 of the present invention. The lightweight ceiling 100 of the fifth embodiment comprises a lightweight darkening structure 119 and a ceiling frame 120.

The ceiling frame 120 of the fifth embodiment

(FIG. 17) comprises multiple frame sections 120a, 120b, 120c, 120d. The frame sections 120a, 120b, 120c, 120d are preferably fiber, resin, or aluminum tubes joined by ferrule connectors (either internal or external) and optionally corded with shock cord for convenience of assembly, constructed similarly to conventional extendable tent poles. The tubular frame sections 120a, 120b, 120c, 120d are inserted into frame-receiving pockets 145 of the darkening structure 119 to provide rigidity to the ceiling frame 120.

The darkening structure 119 of the fifth embodiment (FIG. 17) is a lightweight blackout fabric rolled over the ceiling frame 120, with a light hood opening 141 to allow the light hood to be positioned as in the first embodiment.

The darkening structure 119 of the fifth embodiment is configured with tie-downs 142, 143; with frame restraints 144; with cutout corners 146; and with frame-receiving pockets 145.

The side tie-downs 142 (FIG. 17) and rear tie-downs 143 allow the darkening structure 119 to be secured to the horizontal rods 32, 33, 34 (horizontal rods shown in FIG. 5). The tie-downs 142, 143 preferably loop around the horizontal rods 32, 33, 34 and are secured by complementary hook and loop fasteners.

The frame restraints 144 (FIG. 17) are configured to hold and secure the darkening structure 119 to the ceiling frame 120. Frame restraints 144 may be loops or strips with complementary hook and loop fasteners used to encircle the frame sections 120a, 120b, 120c, 120d.

The frame-receiving pockets 145 are configured to receive the ends of the sections 120a, 120b, 120c, 120d of the tubular ceiling frame 120. The frame-receiving pockets 145 may be formed by attaching a separate fabric pocket to the fabric of the darkening structure 119 or may be formed integrally with the fabric of the darkening structure 119.

The cutout corners 146 are adapted to wrap around the top of the four corner uprights 21, 22, 23, 24. Preferably the cutout corners 146 are configured with complementary hook-and-loop corner fasteners 147 to allow each of the cutout corners 146 to be strapped around one of the four corner uprights 21, 22, 23, 24 and secured.

The lightweight ceiling 100 of the fifth embodiment (FIG. 17) is easily disassembled to form compact components for storage and transport. The ceiling frame sections 120a, 120b, 120c, 120d can be removed from the frame restraints 144 and the frame-receiving pockets 145 and folded to economize on space (folded frame section 148). The darkening structure 119 can be removed from the top of the four corner uprights 21, 22, 23, 24 and folded (folded darkening structure 149).

Although the portable shadow screen kit 10 of the present invention has been described in a size and configuration suitable for a human body to comprise the opaque object 65 that is creating the shadow, the same structures can be made larger or smaller, without departing from the invention. For example, a pet photographer might have need of a similar shadow screen in a proportionally smaller size. Also, the size may be varied depending on the location of use; for instance, a theater might need a wider, narrower, taller, or shorter shadow screen system to fit the allowable space.

Also, although the portable shadow screen kit 10 has been described using round theatrical bars and posts, other similar posts, such as square track, are within the scope of the invention.

Further, a convenient changing room (not shown) may be easily attached to either side of the assembled shadow screen kit. Standard theatrical poles and connections can be used for the expansion, with drapes for privacy. The side drape 60 (FIG. 1) separates the changing room from the shadow screen studio, allowing a user to easily enter.

From the foregoing, it will be apparent that the shadow screen kit 10 of the current invention is easy to assemble, disassemble, store, clean, and transport; thus the shadow screen kit 10 is particularly suited for moving between events, for rental, for parties, for private use, for clubs, or for selling in kit form. The assembled shadow screen kit allows the production of distinct shadows to accommodate shadow dancing, shadow videography, or shadow photography.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

I claim:

1. A portable shadow screen kit for constructing a shadow screen studio, comprising:
a side-and-back exterior enclosure configured to enclose the sides and back of said shadow screen studio;
a screen adapted to enclose the front of said side-and-back exterior enclosure; and
a light source configured to provide light for shining on the back of said screen, wherein an opaque object placed in back of said screen can cast a shadow observable from the front of said screen; and
a light support configured to support said light source.

2. The portable shadow screen kit for constructing a shadow screen studio, as recited in claim 1, further comprising a mirror adapted to reflect said light from said light source onto a back surface of said screen.

3. The portable shadow screen kit for constructing a shadow screen studio, as recited in claim 2, further comprising a mirror stand adapted to support said mirror.

4. The portable shadow screen kit for constructing a shadow screen studio, as recited in claim 3, wherein said mirror stand comprises a plurality of interlocking panels.

5. The portable shadow screen kit for constructing a shadow screen studio, as recited in claim 1, wherein said screen comprises a stretchable fabric.

6. The portable shadow screen kit for constructing a shadow screen studio, as recited in claim 5, wherein said stretchable fabric comprises a spandex blend fabric.

7. The portable shadow screen kit for constructing a shadow screen studio as recited in claim 1, further comprising a lightweight ceiling, wherein said lightweight ceiling comprises a lightweight darkening structure and a ceiling frame.

8. The portable shadow screen kit for constructing a shadow screen studio, as recited in claim 7, wherein said lightweight ceiling is configured to support said light source.

9. The portable shadow screen kit for constructing a shadow screen studio, as recited in claim 8, wherein said side-and-back exterior enclosure comprises:
four bases having a flat foundation;
four corner upright posts each of which is secured in a vertical manner to one of said four bases; each of said four corner upright posts having an upper portion and a lower portion, wherein said four corner upright posts include a right rear corner upright post, a left rear corner upright post, a right front corner upright post, and a left front corner upright post;
four top horizontal rods each having a first end and an opposing second end, wherein said first end and said second end are configured to detachably connect to said upper portion of one of said four corner upright posts; and wherein said four corner upright posts, said four top horizontal rods, and said four bases can be assembled to form a generally rectangular frame defining an interior area of said shadow screen studio; and
a conduit configured to detachably connect between said lower portion of said right front corner upright post and said lower portion of said left front corner upright post.

10. The portable shadow screen kit for constructing a shadow screen studio as recited in claim 9, wherein said ceiling frame comprises:
a plurality of hangers each of which is configured to removably attach to one of said top horizontal rods;
a plurality of cross members, each of said plurality of cross members having a first end configured to removably attach to a first one of said plurality of hangers and having an opposing second end configured to removably attach to a second one of said plurality of hangers, whereupon each of said plurality of cross members with attached said first one and said second one of said plurality of hangers can be suspended between a first one and a second one of said four top horizontal rods; and
a plurality of connecting members, each of which is configured to removably connect between a first one of said plurality of cross members and a second one of said plurality of cross members, wherein said connection of said plurality of connecting members and of said plurality of cross members produces a grid defining a plurality of open inner spaces.

11. The portable shadow screen kit for constructing a shadow screen studio, as recited in claim 10, wherein said lightweight darkening structure comprises a plurality of ceiling panels each of which is configured to fit within one of said plurality of open inner spaces of said lightweight ceiling.

12. The portable shadow screen kit for constructing a shadow screen studio, as recited in claim 10, wherein:
said right front corner upright post is configured with a vertically extending strip of hook-and-loop-type fastener;
the right edge of said screen is configured with a vertically extending strip of complementary hook-and-loop-type fastener, whereby said right edge of said screen is releasably attachable to said right front corner upright post;
said left front corner upright post is configured with a vertically extending strip of hook-and-loop-type fastener; and
the left edge of said screen is configured with a vertically extending strip of complementary hook-and-loop-type fastener, whereby said left edge of said screen is releasably attachable to said left front corner upright post.

13. The portable shadow screen kit for constructing a shadow screen studio as recited in claim 7, wherein:
said ceiling frame comprises multiple tubular frame sections; and
said lightweight darkening structure comprises a blackout fabric.

14. The portable shadow screen kit for constructing a shadow screen studio as recited in claim 7, wherein said mirror comprises a mirrored acrylic sheet.

15. The portable shadow screen kit for constructing a shadow screen studio as recited in claim 7, wherein said mirror comprises a lightweight reflective fabric.

16. A method to assemble a portable shadow screen kit for constructing a shadow screen studio, comprising:
constructing a side-and-back exterior enclosure with four corner uprights to form the sides and back of said shadow screen studio;
enclosing the front of said side-and-back exterior enclosure with a screen;
constructing a lightweight ceiling;
attaching said lightweight ceiling to the top of said side-and-back exterior enclosure to form the ceiling of said shadow screen studio to define an interior area of said shadow screen studio; and
positioning a light source within said interior area of said shadow screen studio to shine on said screen.

17. The method to assemble a portable shadow screen kit for constructing a shadow screen studio, as recited in claim 16, further comprising:
assembling a mirror stand;
attaching a mirror to said mirror stand; and
positioning said mirror stand with said attached mirror within said interior area so that said mirror reflects said light from said light source onto the back of said screen.

18. The method to assemble a portable shadow screen kit for constructing a shadow screen studio, as recited in claim 16, wherein constructing said lightweight ceiling comprises:
assembling a ceiling grid defining a plurality of open inner spaces; and
placing each of a plurality of pre-cut ceiling panels within each of said plurality of open inner spaces of said ceiling grid.

19. The method to assemble a portable shadow screen kit for constructing a shadow screen studio, as recited in claim 16, wherein said mirror comprises a mirrored acrylic sheet.

20. The portable shadow screen kit for constructing a shadow screen studio as recited in claim 16, wherein said mirror comprises a lightweight reflective fabric.

21. The method to assemble a portable shadow screen kit for constructing a shadow screen studio, as recited in claim 16, wherein constructing said lightweight ceiling comprises:
obtaining multiple tubular ceiling frame sections, each of said multiple tubular ceiling frame sections being generally shaped as a jointed rod and having opposing frame section ends;
obtaining a lightweight darkening structure configured with multiple frame-receiving pockets and with four cutout corners;
inserting each of said opposing frame section ends into one of said multiple frame-receiving pockets; and
wrapping each of said four cutout corners around an upper area of one of said four corner uprights.

22. The method to assemble a portable shadow screen kit, as recited in claim 21, wherein said constructing said side-and-back exterior enclosure comprises:
positioning four bases, each of said four bases supporting one of said corner uprights, at approximately the corners of said side-and-back exterior enclosure, thereby resulting in a right front corner upright post, a left front corner upright post, a right rear corner upright post, and a left rear corner upright post;
feeding a front top horizontal post through a top sleeve of a screen;
feeding a conduit through a bottom sleeve of said screen;
attaching said front top horizontal post between an upper area of said right front corner upright post and an upper area of said left front corner upright post;
feeding a right side top horizontal post through a top sleeve of a first drape and through a top sleeve of a second drape;
attaching said right side top horizontal post between said right front corner upright post and said right rear corner upright post;
feeding a left side top horizontal post through a top sleeve of a third drape and through a top sleeve of a fourth drape;
attaching said left side top horizontal post between said left front corner upright post and said left rear corner upright post; and
attaching a rear top horizontal post between an upper area of said right rear corner upright post and an upper area of said left rear corner upright post.

23. The method to assemble a portable shadow screen kit, as recited in claim 22, further comprising:
engaging a strip of hook-and-loop-type fastener disposed on the right side of said screen with a complementary strip of hook-and-loop-type fastener disposed on said right front corner upright post; and
engaging a strip of hook-and-loop-type fastener disposed on the left side of said screen with a complementary strip of hook-and-loop-type fastener disposed on said left front corner upright post, whereby said screen is stretched horizontally.
